(19) United States
(12) Patent Application Publication
(10) Pub. No.: US 2002/0195580 A1
(43) Pub. Date: Dec. 26, 2002

(54) Solenoid valve with magnetic fluid filled between a magnetically conductive winding reel and a magnetically insulating tube

(75) Inventor: Wu-Min Chang, Taichung City (TW)

Correspondence Address: KRAMER, LEVIN, NAFTALIS & FRANKEL LLP, 919 Third Avenue, New York, NY, 10022-3852, US

(73) Assignee: HYDROTEK CORPORATION

(21) Appl. No.: 09/887,614

(22) Filed: Jun. 22, 2001

(51) Int. Cl. F16K 31/08

(52) U.S. Cl. 251/65

(57) ABSTRACT

A solenoid valve includes a valve seat with a hole, a magnetically conductive hollow winding reel, an induction coil unit wound around the reel, a permanent magnet fixed on the reel, and a magnetically insulating vertical tube disposed within the reel. A moving core is biased by a spring to a lower limit position so as to close the hole, thereby preventing water flow though the hole. A magnetic fluid is filled within a sealed gap between the reel and the tube. When a forward current flows through the coil unit, the core is attracted by the magnet so as to move to an upper limit position, where the hole is open, thereby permitting the water flow through the hole. When the core is disposed at the upper limit position and when a reverse current flows through the coil unit, a magnetic repulsion force is created between the magnet and the core, thereby returning the core to the lower limit position with assistance from the spring.

### BACKGROUND OF THE INVENTION

1. Field of the Invention

This invention relates to a solenoid valve, more particularly to a solenoid valve with a magnetically conductive winding reel and a magnetically insulating tube, between which a magnetic fluid is filled, thereby increasing magnetic flux in the moving core.

2. Description of the Related Art

Referring to FIG. 1, a conventional solenoid valve that is used widely in urinals and faucets is shown to include an electromagnetic unit 10 and a valve seat 20, which is formed with a water-guiding hole 21. The unit 10 includes a magnetically conductive housing 11 attached to the valve seat 20, a magnetically conductive hollow winding reel 12, and an induction coil unit 13 wound around the reel 12. A permanent magnet 14 is fixed on an upper end of the reel 12. A magnetically conducting member 15 is fixed in an upper end of a magnetically insulating vertical tube 16, which is disposed between and which insulates the reel 12 and a moving core 18 magnetically from each other. A coiled compression spring 17 is disposed in the tube 16 so as to bias the moving core 18 away from the conducting member 15 to a lower limit position, where a switching member (not shown) is in an OFF state and where the moving core 18 abuts against the valve seat 20 so as to close the hole 21 in the valve seat 20, thereby preventing water flow through the hole 21.

Referring to FIG. 2, when the switching member (not shown) is actuated so as to revert to an ON state such that a forward current flows through the coil unit 13, the moving core 18 is attracted by the permanent magnet 14 so as to move to an upper limit position, where the moving core 18 is removed from the valve seat 20 so as to open the hole 21, thereby permitting the water flow through the hole 21. Subsequently, the switching member (not shown) can revert to its original position so that a reverse current flows through the coil unit 13, thereby returning the moving core 18 to the lower limit position shown in FIG. 1. The aforesaid conventional solenoid valve has a disadvantage in that the turn number of the coil unit 13 is relatively large, thereby resulting in higher manufacturing costs, and increased volume and weight of the valve.

### SUMMARY OF THE INVENTION

An object of this invention is to provide a solenoid valve with a magnetic fluid that is disposed between a magnetically conductive winding reel and a magnetically insulating tube so as to increase magnetic flux in a moving core, thereby permitting a reduction in the turn number of a coil unit without affecting adversely the function of the coil unit.

According to this invention, a solenoid valve includes a valve seat with a hole, a magnetically conductive hollow winding reel, an induction coil unit wound around the reel, a permanent magnet fixed on the reel, and a magnetically insulating vertical tube disposed within the reel. A moving core is biased by a spring to a lower limit position so as to close the hole, thereby preventing water flow though the hole. A magnetic fluid is filled within a sealed gap between the reel and the tube. When a forward current flows through the coil unit, the core is attracted by the magnet so as to move to an upper limit position, where the hole is open, thereby permitting the water flow through the hole. When the core is disposed at the upper limit position and when a reverse current flows through the coil unit, a magnetic repulsion force is created between the magnet and the core, thereby returning the core to the lower limit position with assistance from the spring.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is a sectional view of a conventional solenoid valve when a moving core is disposed at a lower limit position;

FIG. 2 is a sectional view of the conventional solenoid valve when the moving core is moved to an upper limit position;

FIG. 3 is a sectional view of a preferred embodiment of a solenoid valve according to this invention; and

FIG. 4 is a sectional view of another preferred embodiment of the solenoid valve according to this invention.

### DETAILED DESCRIPTION OF THE PREFERRED EMBODIMENTS

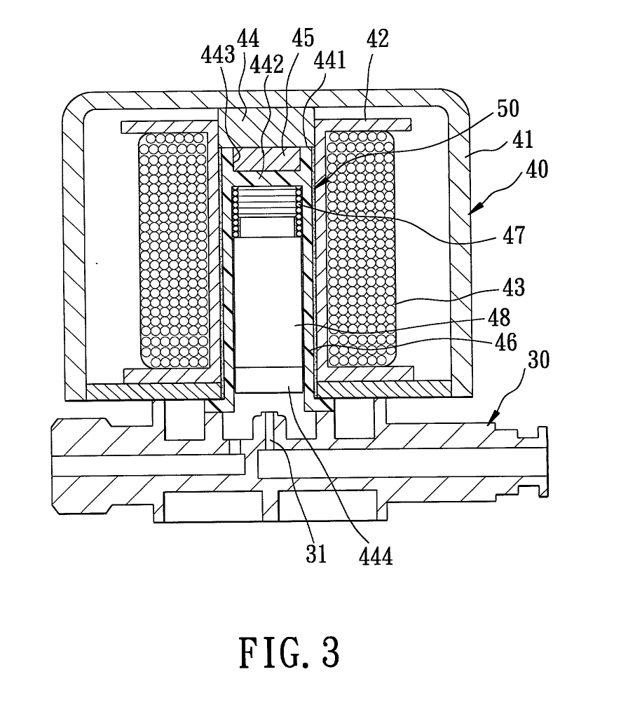

Referring to FIG. 3, a preferred embodiment of a solenoid valve according to this invention is shown to include a valve seat 30 with a water-guiding hole 31, and an electromagnetic unit 40 that is disposed over the seat 30. The unit 40 includes a magnetically conductive housing 41 fixed on the seat 30, a magnetically conductive hollow winding reel 42 fixed within the housing 41, and an induction coil unit 43 wound around the reel 42.

A permanent magnet 44, a magnetically conducting member 45, and a magnetically insulating vertical tube 46 are fixed within the reel 42 in a known manner. The tube 46 is made of plastic, and has an upper distal end 441 that abuts against the permanent magnet 44, and an upper end portion that is formed with an integral horizontal partition 442 so as to form a pair of upper and lower chambers 443, 444 within the tube 46. The conducting member 45 is disposed within the upper chamber 443, and is located between the partition 442 and the permanent magnet 44.

A coiled compression spring 47 and a moving core 48 are disposed within the lower chamber 444 in the tube 46 in a known manner. The spring 47 is located between the partition 442 and the moving core 48 so as to bias the moving core 48 to move downward. The moving core 48 can be moved in a known manner between a lower limit position, where the moving core 48 abuts against the seat 30 so as to close the hole 31 in the seat 30, thereby preventing water flow through the hole 31, and an upper limit position shown in FIG. 3, where the moving core 48 separates from the seat 30 so as to open the hole 31, thereby permitting the water flow through the hole 31.

When the moving core 48 is disposed at the lower limit position and when a push-button type switch (not shown) is pressed so as to revert to an ON state, a forward current flows through the coil unit 43 such that the moving core 48 is attracted and moved to the upper limit position by the permanent magnet 44.

When the moving core 48 is disposed at the upper limit position and when the switch (not shown) is released so as to revert to an OFF state, a reverse current flows through the coil unit 43 so as to create a magnetic repulsion force between the permanent magnet 44 and the moving core 48, thereby returning the moving core 48 to the lower limit position with assistance from the spring 47.

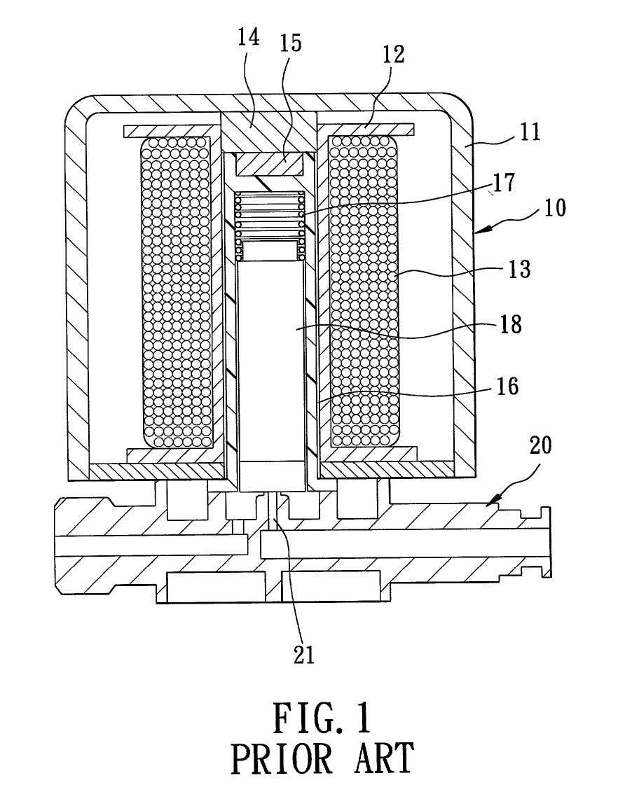

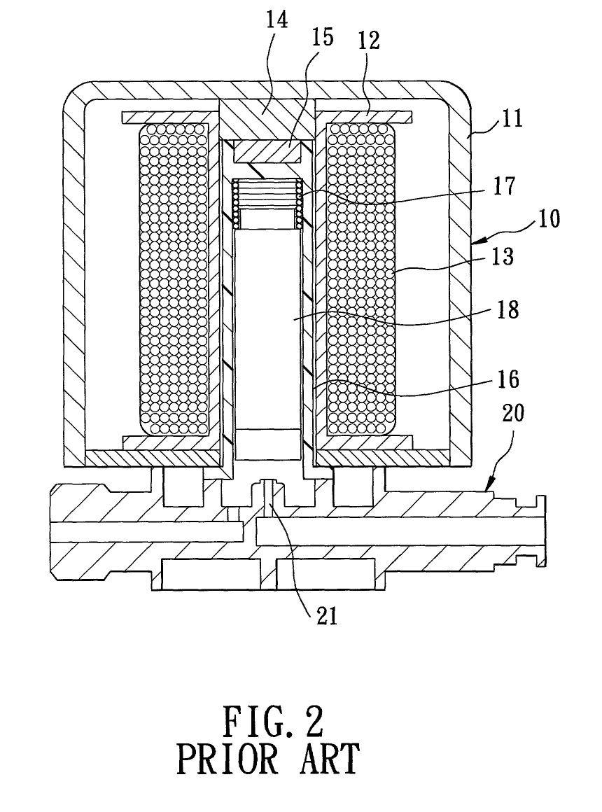

The tube 46 is disposed between the reel 42 and the moving core 48 so as to insulate the moving core 48 magnetically from the reel 42. Assembly of the tube 46 and the reel 42 is similar to that of the conventional valve shown in FIGS. 1 and 2 in construction except that a first magnetic fluid 50 is filled within a sealed gap between the tube 46 and the reel 42. The magnetic fluid 50 is a mixture of magnetic particles, such as iron ions, cobalt ions, and nickel ions, and a liquid. Accordingly, magnetic flux in the moving core 48 can be increased so as to permit a reduction in the turn number of the coil unit 43 with the result that a sufficient amount of magnetic flux can still be produced in the moving core 48.

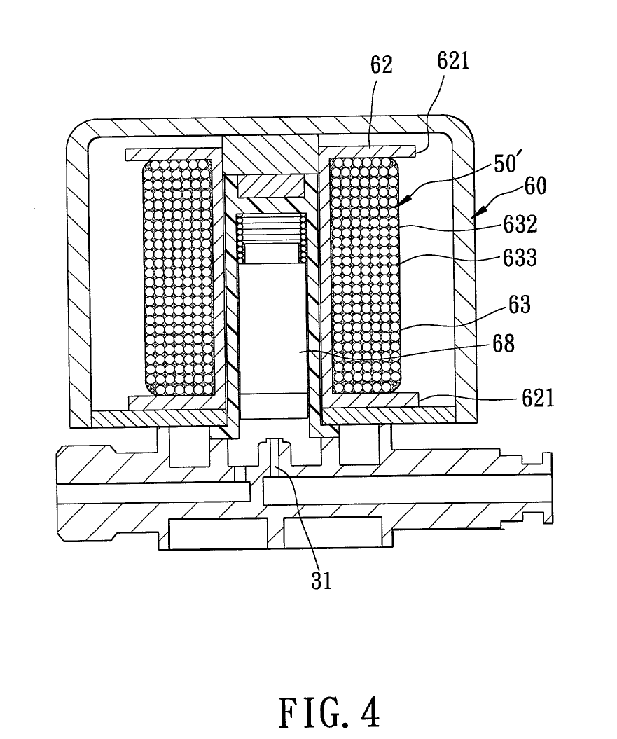

FIG. 4 shows a modified assembly 60 of a reel 62 and a coil unit 63. The reel 62 is formed with a pair of integral upper and lower flanges 621, which extend respectively, radially, and outwardly from upper and lower ends thereof. The coil unit 63 is wound around the reel 62. A generally circular tubular coating 632 is disposed around the coil unit 63 and between the upper and lower flanges 621 of the reel 62, thereby forming a sealed room 633 among the reel 62, the coil unit 63, and the coating 632. The room 633 is filled with a second magnetic fluid 50′ so as to further increase the magnetic flux in a moving core 68. The coating 632 is made of a liquid impermeable material so as to prevent flow of the second magnetic fluid 50′ from the room 633.

With this invention thus explained, it is apparent that numerous modifications and variations can be made without departing the scope and spirit of this invention. It is therefore intended that this invention be limited only as indicated by the appended claims.

I claim:

1. A solenoid valve comprising:
a valve seat with a water-guiding hole;
an electromagnetic unit including
a magnetically conductive housing attached to said valve seat,
a magnetically conductive hollow winding reel disposed fixedly within said housing and located over said valve seat,
an induction coil unit wound around said reel,
a permanent magnet fixed on said reel,
a magnetically insulating vertical tube disposed within said reel so as to form a sealed gap therebetween,
a moving core disposed vertically and movably within said tube under said permanent magnet and in magnetic communication with said permanent magnet, and
a spring for biasing said moving core away from said permanent magnet to a lower limit position, where said moving core abuts against said valve seat so as to close said hole in said valve, thereby preventing water flow through said hole in said valve seat; and
a first magnetic fluid filled within said sealed gap between said reel and said tube so as to increase magnetic flux in said moving core;
wherein when a forward current flows through said coil unit, said moving core is attracted by said permanent magnet so as to move to an upper limit position, where said hole in said valve seat is open, thereby permitting the water flow through said hole in said valve seat; and
wherein when said moving core is disposed at the upper limit position and when a reverse current flows through said coil unit, a magnetic repulsion force is created between said permanent magnet and said moving core, thereby returning said moving core to the lower limit position with assistance from said spring.

2. The solenoid valve as claimed in claim 1, wherein said tube has an open upper distal end that abuts against said permanent magnet, and an upper end portion that is formed with an integral horizontal partition so as to form a pair of upper and lower chambers within said tube, said upper chamber being located over said lower chamber, said moving core being disposed in said lower chamber, said spring being configured as a coiled compression spring, which is disposed in said lower chamber and which is located between said partition and said moving core so as to bias said moving core to move downward, said solenoid valve further including a magnetically conducting member, which is disposed within said upper chamber in said tube and which is located between said partition and said permanent magnet.

3. The solenoid valve as claimed in claim 1, wherein said reel is formed with a pair of integral upper and lower flanges, which extend respectively, radially, and outwardly from upper and lower ends thereof, said solenoid valve further including a generally circular tubular coating, which is disposed around said coil unit and between said upper and lower flanges of said reel so as to form a sealed room among said reel, said coating, and said coil unit, said sealed room being filled with a second magnetic fluid, thereby further increasing the magnetic flux in said moving core, said coating being made of a liquid impermeable material so as to prevent flow of said second magnetic fluid from said room.
